(19) United States
(12) Patent Application Publication
(10) Pub. No.: US 2015/0302555 A1
(43) Pub. Date: Oct. 22, 2015

(54) AUTOMATED CARDIOPULMONARY RESUSCITATION DEVICE WITH A DISPLAY

(71) Applicant: KONINKLIJKE PHILIPS N.V., Eindhoven (NL)

(72) Inventors: IGOR WILHELMUS FRANCISCUS PAULUSSEN, NUENEN (NL); GERRIT JAN NOORDERGRAAF, DIESSEN (NL); CHRISTIAN JAMES RICHARD, SHORELINE, WA (US); PETER BINGLEY, MIERLO (NL); VIRGINIA HIGLEY, TYNGSBORO, MA (US); DAWN BUTLER, ANDOVER, MA (US)

(21) Appl. No.: 14/441,924

(22) PCT Filed: Dec. 2, 2013
(86) PCT No.: PCT/IB2013/060562

§ 371 Date: May 11, 2015

Related U.S. Application Data
(60) Provisional application No. 61/739,073, filed on Dec. 19, 2012.
(60) Provisional application No. 61/736,042, filed on Dec. 12, 2012.

(51) Int. Cl. G06T 3/60; A61H 31/00

(52) U.S. Cl. CPC G06T 3/60; A61H 31/005; G06T 2210/41; A61H 2201/5043

(57) ABSTRACT

The invention relates to an automated CPR device for performing automated chest compressions of a patient. The CPR device is provided with display processing electronics for processing information data so that display content associated with the information data can be displayed in different rotated orientations so that the information can be oriented correctly relative to a user's viewing direction. The CPR device is configured with an orientation button for activating rotation of the displayed information. The orientation button is configured so that the location of the button relative to display content, at least along a single dimension, is the same. For example, the orientation button may be located adjacent to the middle of an edge of the display so that the button remains located adjacent to information located in the center of the display irrespective of the displayed orientation of the information, irrespective of the two orientations.

### FIELD OF THE INVENTION

The invention relates to automated cardiopulmonary resuscitation devices and in particular to displays for such devices.

### BACKGROUND OF THE INVENTION

During use of an automated cardiopulmonary resuscitation device (ACPR device) in a resuscitation situation it is important that the caregiver is able to operate the device correctly and read information displayed by the device as easy as possible in a typically stressed situation. Such situations may complicate operation of the device due to e.g. non-optimal light conditions where sun-light, darkness, strobe lights from an ambulance makes it harder to read e.g. the display. In another situation positioning of the caregiver may make operation of the device more difficult compared to an ideal situation. Therefore, it is important that the device is as user friendly as possible to avoid incorrect operation of the device and wrong reading of displayed information, e.g. instructions to the caregiver. Accordingly, it is important that the user interface of such a device is configured so that the risk of faulty operation and information reading is minimized.

Thus, it is a problem that existing ACPR devices may be incorrectly operated or that displayed information from the device may be misinterpreted during a typically stressed resuscitation situation.

U.S. Pat. No. 6,230,053 discloses a defibrillator having an integrated surveillance monitor, on the screen of which vital parameters of a patient can be displayed in the form of a rotatable screen content, having a built-in accumulator for power supply independently of the main power supply and having a connection device for external power supply and for recharging the accumulator. The screen content is rotatable from a first position relative to the housing to a second position relative to the housing in response to a change in position of the housing.

The inventor of the present invention has appreciated that an improved ACPR device is of benefit, and has in consequence devised the present invention.

### SUMMARY OF THE INVENTION

It would be advantageous to achieve improvements of ACPR devices. It would also be desirable to achieve improved user friendliness of ACPR devices. In general, the invention preferably seeks to mitigate, alleviate or eliminate one or more of the above mentioned disadvantages of existing ACPR devices singly or in any combination. In particular, it may be seen as an object of the present invention to provide a method that solves the above mentioned problems, or other problems, of the prior art.

To better address one or more of these concerns, in a first aspect of the invention an automated cardiopulmonary resuscitation device for performing chest compressions of a patient is presented that comprises
a display for displaying information, wherein the display is configured to display the information in at least first and second different orientations where the first orientation is rotated relative to the second orientation,
an orientation button for changing the orientation of the displayed information, wherein the orientation button is configured so that it has the same location relative to the displayed information along a single dimension both when the information has the first orientation and the second orientation.

Advantageously, the configuration of the orientation button may improve the use of the ACPR device since a rescuer using the device may experience that the orientation button has the same relative location substantially independent of the location of the rescuer. That is, the rescuer may experience that the orientation button has the same relative location along a horizontal dimension of the display whether the rescuer is located on one side of the device or an opposite side of the device, e.g. if the information is rotatable between 0 degrees and 180 degrees. Alternatively or additionally, the rescuer may experience that the orientation button has the same relative location along a vertical dimension of the display whether the rescuer is located on one side of the device or an opposite side of the device, e.g. if the information is rotatable between 90 degrees and 270 degrees. Generally, the ACPR device may be configured via the orientation button so that the orientation button has the same location relative to the displayed information along a vertical dimension and/or along a horizontal dimension both when the information has the first orientation and the second orientation. The first orientation may refer to e.g. zero degrees and the second orientation may refer to any of 90, 180, 270 or other degrees of rotation.

Further, the same relative location may refer to the same location in a left-to-right direction or the same absolute location in a single direction. Alternatively or additionally, the same relative location may refer to the same location in a top-to-bottom direction.

The orientation button may be configured according to different examples given herein. For example, orientation buttons may be located both below and above the horizontal sides of the display. Alternatively or additionally, orientation buttons may be located both to the left and to the right of the vertical sides of the display. The buttons may be configured as mechanical buttons and/or as soft keys. By matching the first and second different orientations of the information with any of the possible locations of the orientation buttons the advantageous effect of maintaining the location of the rotation button relative to the displayed information along any direction or dimension may be achieved.

Thus, as the rescuer moves e.g. from the feet of the patient to the head of the patient the rescuer can press the orientation button so that the information in the display is oriented correctly relative to the rescuer's location. However, even though the rescuer has moved to an opposite side of the ACPR device, near the patient's head, the rescuer may experience that the orientation button is located as expected since it has the same relative location—at least in one direction—as when the rescuer was located near the patient's feet.

In an embodiment the information comprises first display content and second display content where the second display content is associated with the orientation button, and wherein the display is configured to rotate the first display content about a first point in a plane of the display and to rotate the second display content about a second point in the plane of the display.

Since the second display content, e.g. text or a symbol for the orientation button, may be rotated about a different rotation point than the rotation point of the first display content, the second display content may maintain its left-to-right (and/or top-to-bottom) location relative to the orientation button at the same time as different display contents are rotated.

In an embodiment the display is further configured to translate the second display content in the plane of the display. Translating the display content associated with the orientation button moves the orientation button location from e.g. a left side of the display to a right side of the display (when seen from one direction) so that a rescuer may experience that the orientation button has the same left-to-right (and/or top-to-bottom) location relative to rotated first display information whether the rescuer is located on one side of the device or an opposite side of the device

In an embodiment the second rotation point is located within an area of the second display content so that the second display content remains at the same location relative to the orientation button (i.e. in at least one dimension) whether the second display content is displayed in the first or second orientation. For example, the second rotation point may be located in the center of the second display content so that the second display content merely is rotated about itself.

In an embodiment the automated cardiopulmonary resuscitation device is configured to change an assignment of a function for changing the orientation of the displayed information from one of the buttons to another of the buttons. Accordingly, as the second display content is moved from one button to another button, the rotation function would similarly be moved from one button to another button.

In an embodiment the information further comprises third display content associated with a second button and the display may be configured to rotate the third display content about a third point in a plane of the display. Thus, buttons for functions other than rotation of the display content may be provided and such buttons may also have associated rotatable display contents for illustrating the function of the button.

In an embodiment the display is further configured to translate the third display content in the plane of the display. In a related embodiment the automated cardiopulmonary resuscitation device (e.g. a processor of the device or the display) is configured to change a function associated with the second button with another function.

In an embodiment the orientation button is a mechanical button located adjacent to the display e.g. above, below, or either side.

In an embodiment an area of the display is touch sensitive and configured to constitute the orientation button. Accordingly, the orientation button may be part of the display. Additionally, the touch sensitive area may be capable of displaying information. Thereby, the orientation button (or other buttons) and display content associated with the orientation button may be combined.

In an embodiment the display is fixed non-moveably relative to the automated cardiopulmonary resuscitation device.

A second aspect of the invention relates to a method for displaying information 102 on a display 101 of an automated cardiopulmonary resuscitation device 100 capable of performing chest compressions of a patient, the method comprises
displaying the information in at least first and second different orientations where the first orientation is rotated relative to the second orientation,
changing the orientation of the displayed information by use of an orientation button, wherein the orientation button is located so that it has the same location relative to the displayed information along a single dimension both when the information has the first orientation and the second orientation.

In general the various aspects of the invention may be combined and coupled in any way possible within the scope of the invention. These and other aspects, features and/or advantages of the invention will be apparent from and elucidated with reference to the embodiments described hereinafter.

In summary the invention relates to an automated CPR device for performing automated chest compressions of a patient. The CPR device is provided with display processing electronics for processing information data so that the information content associated with the information data can be displayed on a display in different rotated orientations so that the information can be oriented correctly relative to a user's viewing direction towards the display. The CPR device is configured with an orientation button for activating rotation of the displayed information. The orientation button may be located relative to the display so that the location of the button relative to first and second rotated information orientations, at least along a single dimension, is the same. For example, the orientation button may be located adjacent to the middle of an edge of the display so that the button remains located adjacent to information located in the center of the display irrespective of the displayed orientation of the information, at irrespective of two orientations. That is if the display is viewed from a first viewing direction of zero degrees and a counter viewing direction of 180 degrees, the orientation button remains located adjacent to display content located in the middle of the display. The display and display processing electronics may further be configured to display information for informing the user about the function of the orientation button, i.e. information associated with the orientation button, where the associated information can be displayed in at least two orientations so the that the function of the orientation button can be “read” from at least two viewing directions.

### BRIEF DESCRIPTION OF THE DRAWINGS

Embodiments of the invention will be described, by way of example only, with reference to the drawings, in which

FIG. 1 shows the display 101 of an ACPR device 100 wherein information 102 in the display has a first orientation, and

FIG. 2 shows the display 101 of an ACPR device wherein information 102 in the display has a second orientation.

### DESCRIPTION OF EMBODIMENTS

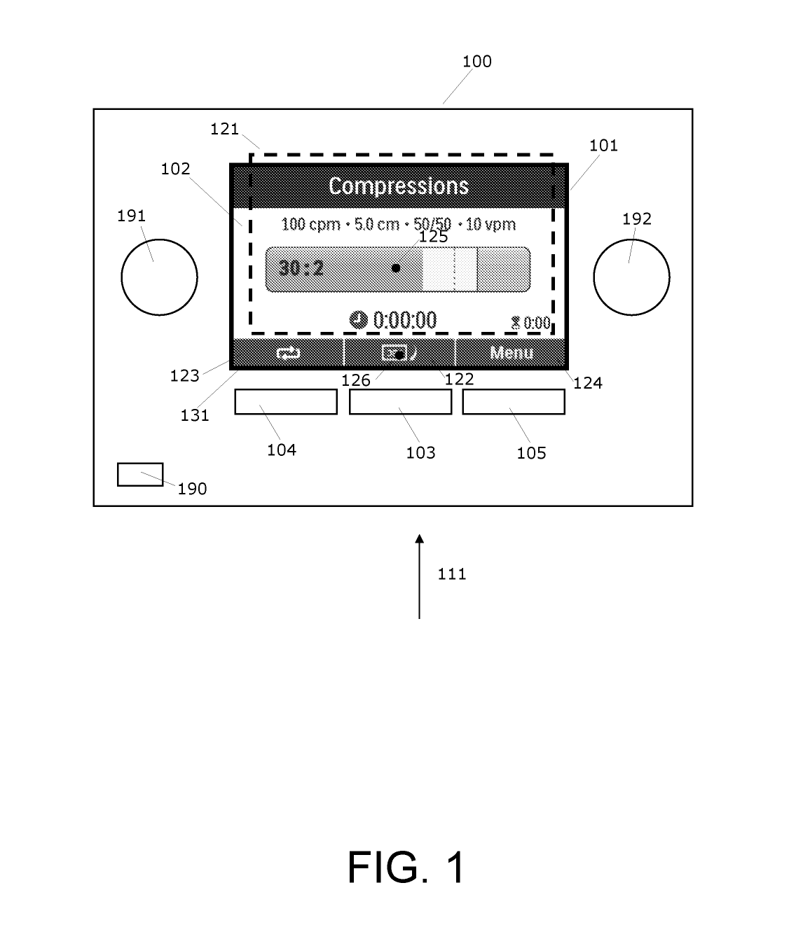

FIG. 1 illustrates an embodiment of an automated cardio pulmonary resuscitation device 100 (ACPR device). The ACPR device 100 is capable of providing automated mechanical automated cardio pulmonary resuscitation of a patient. The ACPR device may be provided with an electrically actuated contact pad for performing compressions of the patient's chest.

The ACPR device 100 is provided with a display 101 which may provide information for guiding the caregiver through an initial setup procedure in order to ensure correct chest compressions and/or the display 101 may provide information, e.g. duration of the chest compressions, to the caregiver during operation of the ACPR device. In an embodiment, the display 101 is fixed non-moveably relative to the ACPR device, e.g. the display may be fixed to a surface of the ACPR device.

During a resuscitation of a patient the ACPR device is positioned stationary relative to the patient in order performing compressions of the patient's chest.

The ACPR device is placed over the chest of the patient and, therefore, the display 101 is configured to be viewable from above so that when the device is used the display is viewable e.g. by a standing or kneeling caregiver. The caregiver may be located at a location near the patient's feet, head or elsewhere and may move during the period where the ACPR device is set up and/or during the period where automated chest compressions are provided.

In order to enable the caregiver or other user to see the information in the display 101 whether the caregiver is located near the patient's feet or head the display 101 is configured so that the at least part of the information displayed in the display 101 can be rotated so that the orientation of the information matches the caregiver's viewing direction. Accordingly, the display may be configured to display the information in at least first and second different orientations where the first orientation is rotated relative to the second orientation, e.g. by 180 degrees.

FIG. 1 shows a situation where the information or display content 102 has a first orientation so that the information can be viewed correctly by a person looking towards the display 100 along the first viewing direction 111.

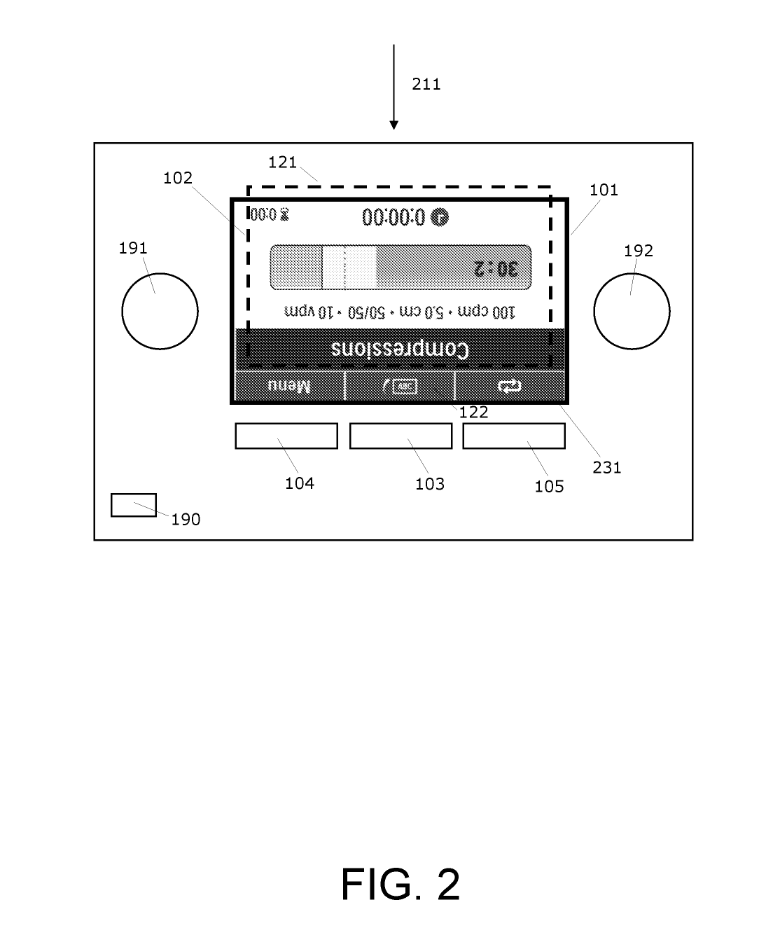

FIG. 2 shows a situation where the information or display content 102 in the same display 101 has a second orientation so that the information can be viewed correctly by a person looking towards the display 101 along the second viewing direction 211. Here the second viewing direction 211 and the second orientation are rotated approximately 180 degrees relative to the first viewing direction 111 and the first orientation.

For example, the first orientation of the information 102 is suited for a caregiver or other person located near the feet of a patient, whereas the second orientation of the information 102 is suited for a caregiver located near the head of a patient.

Thus, the first and second orientations define first and second viewing directions from which the information is optimally viewed. Of course this does not exclude that the information cannot be viewed from other directions, but clearly it is difficult to view the information 102 correctly along the opposite direction 211.

The rotations of the first and second orientations are defined as rotations about a normal direction of the display so that the information can be viewed correctly from at least two different viewing directions defined in the plane of the display.

The ACPR device further comprises an orientation button 103 for changing the orientation of the displayed information 102. The orientation button 103 may be located so that it has the same or substantially the same location in at least one dimension relative to the displayed information 102 or relative to other characteristics displayed in the display 101 whether the information 102 is displayed in the first orientation or the second orientation.

Thus, referring to FIG. 1 or FIG. 2, the orientation button 103 is located at the same location—along a direction perpendicular to the first and second viewing directions 111, 211—relative to the displayed information 102 presented both in the first and second orientations.

As an example, with reference to FIG. 1 or FIG. 2, the orientation button is located in the middle or substantially in the middle of the extension (i.e. the width) of one of the sides of the rectangular display 101.

Since the orientation button 103 may be fixed relative to the display 101 it may be advantageous to be able to rotate different parts of the rotatable information 102 in the display 101 about different rotation points. Thus, the rotatable information 102, which may include all or part of the displayed information, may comprise first display content 121 and second display content 122. The second display content 122 is associated with the orientation button, here in the form of symbol showing the rotation function of the button 103. The display is configured to rotate the first display content 121 about a first point 125 in a plane of the display and the second display content about a second point 126 in the plane of the display. Thus, the entire display content may be rotated or sections of the display content may be rotated independently.

If the second point 126 is located within an area of the second display content 122, e.g. in the geometric center of the display content 122, the second display content 122 remains at the same location relative to the orientation button 103 whether the second display content is displayed in the first or second orientation as seen by comparing FIG. 1 with FIG. 2. Thus, in the orientation of the first and second display contents 121, 122 in FIG. 1 the display content 122 associated with the button is located near the bottom of the display 101; and in the orientation of the first and second display contents 121, 122 in FIG. 2 the display content 122 associated with the button is located near the top of the display 101 when the display 101 is seen from the respective first and second viewing directions 111, 211.

As shown in the examples in FIG. 1 and FIG. 2 the rotatable display information 102 may further include third display content 123 associated with a second button 104 (FIG. 1), and possibly fourth display content 124 associated with a third button 105 (FIG. 1). In order to ensure that the third display content 123 is located as desired relative to a given button 104, 105 the display 101 may also be configured to rotate the third display content 123 about a third point in a plane of the display and/or to translate the third display content 123 within the display 101.

For example, the third display content 123 may be rotated about a third point (not shown) located within an area of the third display content so that the third display content remains at the same location relative to the second button 104 whether the third display content is displayed in the first or second orientation. With reference to FIG. 1, the third display content 123 is located to the left relative to the viewing direction 111. With a rotation of the third display content 123 about a point located within an area of the third display content, as well as rotations of other display contents 121, 122, in order to arrange the display information 102 is a readable manner relative to a second viewing direction 211 the third display content 123 will appear to the right relative to the new viewing direction 211. Thus, the third display content 123 remains associated with the same button 104, but the location changes from the left of the display to the right of the display.

In order to avoid that the third display content 123 changes location relative to the viewing direction 111, 211 and relative to the rotatable information 102 (at least along a single direction), the third display content 123 (and/or the fourth display content 124) may both be rotated and translated where the translation may involve a translation from a first location 131 (see FIG. 1) to a second location 231 (see FIG. 2) so that the location of the third display content 123 relative to the first and second viewing directions 111, 211 is the same (in a left-to-right and/or top-to-bottom direction) whether the information 102 is oriented in the first or second orientation.

In the example where the third display content 123 is translated in order to maintain the location relative to the viewing directions the third display content 123 does not remain associated with the same button but becomes associated with another button. With reference to FIG. 1 and FIG. 2 it is seen that the due to the translation and rotation of the third display content 123 the third display content changes from being associated with the second button 104 to being associated with the third button 105 (the same principle applies the fourth display content 124).

Accordingly, the ACPR device may be configured to change the function associated with e.g. the second and third buttons 104, 105 when the third display content 123 or other display content is translated in one or two dimensions in the plane of the display 101. Thus, the function associated with a button 104, 105 may be changed to another function. For example, when the third display content 123 is translated from a first location adjacent to the second button 104 to a second location adjacent to the third button 105, the function associated with the third button is changed. For example, the function of the second button 104 to which the third display content 123 is associated when the information 102 is displayed in the first orientation may be interchanged with the function of the third button 105 to which the fourth display content 124 is associated when the information 102 is display in the second orientation in response to an activation of the orientation button 103.

Accordingly, any of the second and third buttons 104, 105 or other buttons may be configured as an orientation button, i.e. configured for changing the orientation of the displayed information 102, Thus, instead of the second display content 122 being associated with the orientation button, the third or fourth display content 123, 124 could be associated with the orientation button.

Accordingly the orientation button may be configured so that it has the same location relative to the displayed information 102 along a single dimension both when the information 102 has the first orientation and the second orientation by locating the orientation button in the middle of an extension of the display, i.e. symmetrically with respect to the display, or by changing an assignment of the rotation function from one of the buttons 104-105 to another of the buttons 104-105, e.g. by assigning the rotation function to a button to which the second display content 122 has been translated to.

In an embodiment the ACPR device 100 is configured with buttons on either side of the display. For example, an orientation button 103-105 (not shown) may be located both above and below the display 101. In that case it may be sufficient to rotate display information 102, e.g. the first and second display content 121,122, about a single point so that the second display content 122 associated with the orientation button is rotated from one side of the display to an opposite side of the display. Accordingly, the orientation button may be configured so that it has the same location relative to the displayed information both along a horizontal dimension and along a vertical dimension.

In alternative embodiments the display 101 is configured to display the information 102 in additional different third and fourth orientations which are different from the first and second orientations. For example, the rotatable information 102 may be rotated by 0, 90, 180 and 270 degrees.

In a given configuration of the ACPR device 100, the orientation button 103 and/or other buttons 104, 105 are mechanical buttons such as soft keys located adjacent to the display 101.

In other configurations of the ACPR device 100, the orientation button 103 and/or other buttons 104, 105 are configured as buttons on a touch screen, i.e. “finger touch buttons”. Accordingly, in an embodiment at least an area of the display 101 is touch sensitive meaning that the area is capable of detecting a finger touch and generating a signal in response to the finger touch. The touch sensitive area can be used instead of mechanical buttons. For example, the touch sensitive area may be capable of detecting the location of a finger touch and from the detected location a certain function such as a rotation of the information 102 may be performed by the display 101 or other display processing electronics.

In an embodiment the touch sensitive area is capable of displaying display content such as the information 102. Accordingly, in an embodiment the touch sensitive area is configured to display at least part of the second display content 122 so that the second display content 122 is displayed at a touch sensitive area configured as the orientation button.

Accordingly, in a configuration of the ACPR device wherein an area of the display 101 is touch sensitive and wherein the touch sensitive area is capable of displaying information 102, any of the rotatable display contents 122-124 associated with a given button 103-105 may also include the orientation button 103-105 itself in the form of a touch sensitive area so that at least part of the display contents 122-124 is common with the touch sensitive area. Accordingly, mechanical buttons located adjacent to the display may not be required.

For example, the second display content 122 in FIG. 1 and FIG. 2 may also include the orientation button 103 in the form of a touch sensitive area, and/or the third display content 123 may also include the second button 104 in the form of a touch sensitive area, and/or the fourth display content 124 may also include the third button 105 in the form of a touch sensitive area.

The ACPR device may include other mechanical buttons 191, 192 e.g. a power button 191 and a startstop button 192.

The processing of display data, e.g. information 102, and/or data from buttons 103-105 may be performed by the display 101, i.e. by processing electronics of the display, or by separate display processing electronics or other general processing electronics 190. In general, the processing of display data, e.g. information 102, and/or data from buttons 103-105 is performed by the ACPR device, i.e. by some processor included in the ACPR device 100. The processing of display data may include rotation of display content 121-124, translation of display content and/or other processing of display data. Furthermore, the processing of data from buttons 103-105 may include receiving data from a button generated by a mechanical button or a “finger touch button”, invoking an action in response to receiving such data, e.g. invoking a rotation of display information 102, and/or other processing such as changing a function associated with a button.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, e.g. a display processing electronic unit or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. An automated cardiopulmonary resuscitation device for performing chest compressions of a patient, the device comprises
a display for displaying information, wherein the display is configured to display the information in at least first and second different orientations where the first orientation is rotated relative to the second orientation, and where the first and second orientations define first and second viewing directions from which the information is optimally viewed,
an orientation button for changing the orientation of the displayed information, wherein the orientation button is configured so that it has the same location relative to the displayed information along a single horizontal or vertical dimension of the display both when the information has the first orientation and the second orientation,
wherein the information comprises first display content and second display content where the second display content is associated with the orientation button and wherein the display is configured to rotate the first display content about a first point in a plane of the display and to rotate the second display content about a second point in the plane of the display.

2. (canceled)

3. A device according to claim 1, wherein the display is further configured to translate the second display content in the plane of the display.

4. A device according to claim 1, wherein the second point is located within an area of the second display content so that the second display content remains at the same location relative to the orientation button whether the second display content is displayed in the first or second orientation.

5. A device according to claim 3, wherein the automated cardiopulmonary resuscitation device is configured to change an assignment of a function for changing the orientation of the displayed information from one of the buttons to another of the buttons.

6. A device according to claim 1, wherein the information further comprises third display content associated with a second button, and wherein the display is configured to rotate the third display content about a third point in a plane of the display.

7. A device according to claim 6, wherein the display is further configured to translate the third display content in the plane of the display.

8. A device according to claim 7, wherein the automated cardiopulmonary resuscitation device is configured to change a function associated with the second button with another function.

9. A device according to claim 1, wherein the orientation button is a mechanical button located adjacent to the display.

10. A device according to claim 1, wherein an area of the display is touch sensitive and configured to constitute the orientation button.

11. A device according to claim 10, wherein the touch sensitive area is capable of displaying information.

12. A device according to claim 1, wherein the display is fixed non-moveably relative to the automated cardiopulmonary resuscitation device.

13. A method for displaying information on a display of an automated cardiopulmonary resuscitation device capable of performing chest compressions of a patient, the method comprises
displaying the information in at least first and second different orientations where the first orientation is rotated relative to the second orientation, and where the first and second orientations define first and second viewing directions from which the information is optimally viewed,
changing the orientation of the displayed information by use of an orientation button, wherein the orientation button is located so that it has the same location relative to the displayed information along a single horizontal or vertical dimension of the display both when the information has the first orientation and the second orientation,
wherein the information comprises first display content and second display content where the second display content is associated with the orientation button, and wherein the method further comprises,
rotating the first display content about a first point in a plane of the display and rotating the second display content about a second point in the plane of the display.
